(19) United States
(12) Patent Application Publication
(10) Pub. No.: US 2008/0156515 A1
(43) Pub. Date: Jul. 3, 2008

(54) SLIDING COVER FOR ELECTRICAL SOCKETS

(76) Inventor: Peigen Jiang, Sammamish, WA (US)

Correspondence Address: PEIGEN JIANG, 19480 SE 28TH PLACE, SAMMAMISH, WA, 98075, US

(21) Appl. No.: 11/616,759

(22) Filed: Dec. 27, 2006

(51) Int. Cl. H02G 3/14

(52) U.S. Cl. 174/67

(57) ABSTRACT

An electrical socket cover is disclosed which comprises a base plate having a plurality of apertures for exposing a plurality of electrical sockets, respectively, a cover plate when in a closed position substantially covers the plurality of electrical sockets, a sliding means that allows the cover plate to slidably engage the base plate, and a locking means comprising a pin retained by the base plate, a spring mounted on the base plate for urging the pin toward the cover plate, and an opening on the cover plate for accommodating the pin, wherein when in the closed position one end of the pin is inserted in the opening of the cover plate for locking the cover plate, and when the pin is pressed away from the cover plate, the cover plate is unlocked and slidable to an open position for exposing the plurality of electrical sockets.

### BACKGROUND

The present invention relates generally to electrical sockets, and, more particularly, to electrical sockets with safety covers.

Electrical sockets for supplying electrical power to electrical equipments are common fixtures in homes and other buildings. Electrical sockets of conventional electrical receptacles are exposed, that poses a child safety hazard, as curiosity may induce a child to insert objects into openings of the electrical sockets, and get injured or even be killed.

Because of this safety hazard, many devices to limit children's access to the receptacles have been designed and marketed. For example, plastic safety plugs with prongs that fit snugly into the openings of an electrical socket are readily available on the market. But it is not convenient to always have to unplug and plug such a plastic safety plug when one needs to use an electrical socket.

Other safety devices for electrical outlets are known in the art. For example, U.S. Pat. No. 7,094,969 issued to In provides a base plate with a top panel, on which a spring loaded locking means is devised. A sliding cover plate joins the top panel and is locked by the spring loaded locking means when the sliding cover plate is in the closed position to limit access to the electrical outlet. Although this device offers secured covering of the electrical outlets, it may not be very cost effective as a top panel on the base plate is added.

U.S. Pat. No. 6,342,676 issued to Ha teaches a safety guard device for an electrical socket which comprises a base plate and a sliding cover plate. The sliding cover plate contains an aperture which is positioned to provide selective registry with at least one aperture in the base plate and thus access to the electrical receptacle. Such aperture on the sliding cover plate requires a complicated alignment mechanism between the base plate and the sliding cover plate and also makes the cover plate less ornamental.

As such, what is desired is an electrical socket safety cover that is secure and easy to operate, as well as makes the electrical socket less conspicuous.

### SUMMARY

This invention discloses an electrical socket cover which comprises a base plate mounted on an electrical receptacle that contains a plurality of electrical sockets, the base plate having a plurality of apertures for exposing the plurality of electrical sockets, respectively, a cover plate when in a closed position substantially covers the plurality of electrical sockets, a sliding means that allows the cover plate to slidably engage the base plate, and a locking means comprising a pin retained by the base plate, a spring mounted on the base plate for urging the pin toward the cover plate, and an opening on the cover plate for accommodating the pin, wherein when in the closed position one end of the pin is inserted in the opening of the cover plate for locking the cover plate, and when the pin is pressed away from the cover plate, the cover plate is unlocked and slidable to an open position for exposing the plurality of electrical sockets.

The construction and method of operation of the invention, however, together with additional objectives and advantages thereof will be best understood from the following description of specific embodiments when read in connection with the accompanying drawings.

### BRIEF DESCRIPTION OF THE DRAWINGS

FIG. 1 is a perspective view of an electrical socket cover with a sliding cover plate according to one embodiment of the present invention.

FIG. 2 is a bottom view of the electrical socket cover.

FIG. 3 is a sectional view of the electrical socket cover.

FIG. 4 is a top view of a leaf spring.

FIG. 5 is another sectional view of the electrical socket cover.

### DESCRIPTION

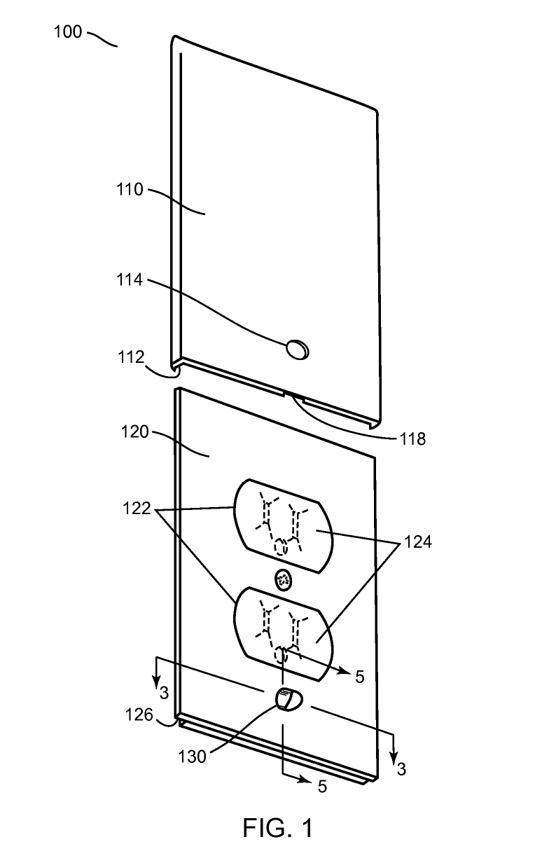

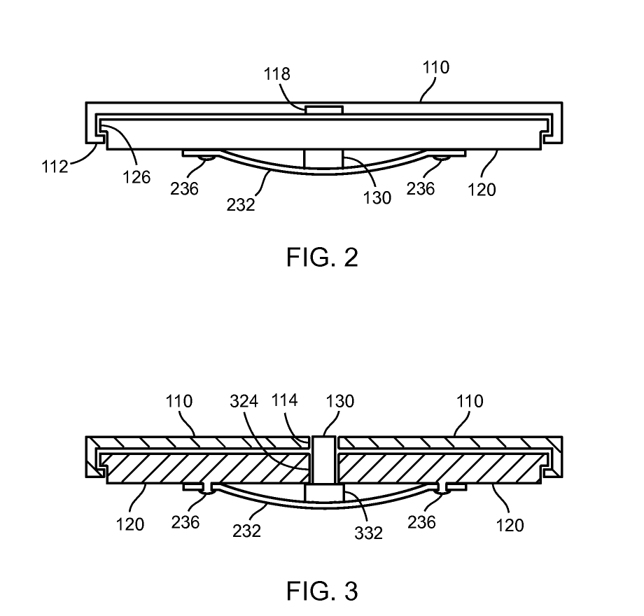

FIG. 1 is a perspective view of an electrical socket cover 100 with a sliding cover plate 110 according to one embodiment of the present invention. Beside the sliding cover plate 110, the electrical socket cover 100 comprises a base plate 120 with two apertures 122 for exposing two electrical sockets 124. A surface of the base plate 120 is approximately flush with surfaces of the electrical sockets 124. Each vertical side of the sliding cover plate 110 has a groove 112 that is designed to fit over a vertical side 126 of the base plate 120, so that the cover plate 110 can slide up and down the base plate 120. The sliding cover plate 110 also has an opening 114 designed to accommodate a spring loaded pin 130 extruded from the base plate 120. A spring (shown in FIGS. 2 through 5) urges the pin 130 toward the sliding cover plate 110 and to slide into the opening 114, thereby locking the sliding cover plate 110 in a position that covers the electrical sockets 124. When the pin 130 is pushed away from the sliding cover plate 110, the sliding cover plate 110 is unlocked and may be slid up or down to reveal one or more electrical sockets 124. The sliding cover plate 110 may even be completed slid off the base plate 120. A slot 118 on the back side of the sliding cover plate 110 facilitates the sliding cover plate 110 being slid back onto the base plate 120. Following drawings will provide more details of the embodiment of the present invention.

Although the cover plate 110 having the grooves 112 is described, one having skills in the art would recognize that the base plate 120 may instead have grooves on its vertical edges, that may fit a sliding cover plate with flat vertical sides.

FIG. 2 is a bottom view of the electrical socket cover. A side 126 of the base plate 120 fits in a groove 112 of the sliding cover plate 110. The slot 118 is made at the bottom side of the sliding cover plate 110. A leaf spring 232 for urging the pin 130 toward the sliding cover plate 110 is mounted on the back side of the base plate 120 by a rivet 236 on each side of the leaf spring 232.

FIG. 3 is a sectional view of the electrical socket cover 100 of FIG. 1 taken at the sectioning plane and in the direction indicated by section lines 3-3. When the sliding cover plate 110 is in the right place, i.e., the opening 114 is aligned with the pin 130, the pin 130 will be inserted into the opening 114, therefore locking the sliding cover plate 110. The pin 130 can be pushed down and disengage the sliding cover plate 110. The leaf spring 232 also serves to retain the pin 130. A bottom portion 332 of the pin 130 is larger than an opening 324 of the base plate 120 for preventing the pin 130 from being pushed off the electrical socket cover 100.

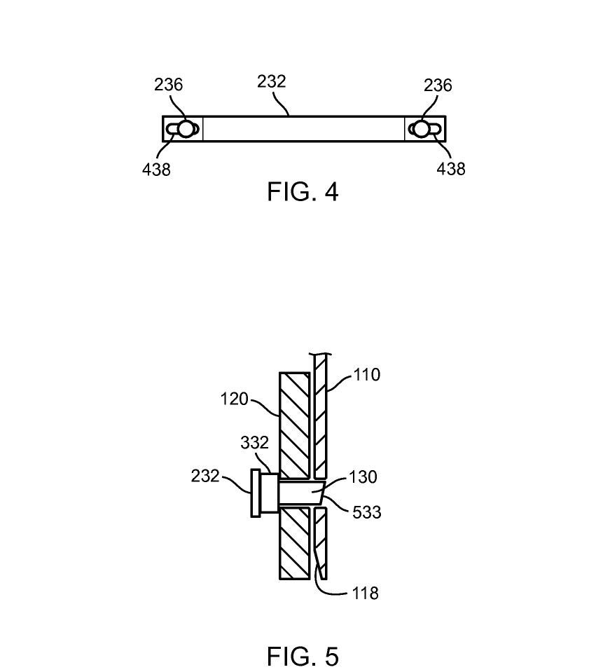

FIG. 4 is a top view of the leaf spring 232. There is an elongated opening 438 at each end of the leaf spring 232. The rivet 236 goes through the elongated opening 438 to mount the leaf spring 130 to the base plate 120, and also allows the leaf spring 232 to bend when the pin 130 is pressed.

FIG. 5 is another sectional view of the electrical socket cover 100 of FIG. 1 taken at the sectioning plane and in the direction indicated by section lines 5-5. One end of the pin 130 has a slanted surface 533 to facilitate the sliding cover plate 110 to disengage the pin 130. The slot 118 also having a slanted surface, on the other hand, is to allow the sliding cover plate 110 to easily slide back into the locking position, where the pin 130 is inserted in the opening 114 of the sliding cover plate 110.

Referring the FIG. 5, it is apparent to one having skills in the art that the slanted surfaces of both the pin 130 and the slot 118 are not necessary to practice the present invention. A straight surface of the pin 130 may require the pin 130 to be pressed a longer distance. Similarly, if the slot 118 does not have the slanted surface or simply does not exists, sliding back the sliding cover plate 110 may require the pin 130 to be pressed down before engaging the sliding cover plate 110 with the base plate 120.

Although the leaf spring 232 for urging the pin 130 toward the sliding cover plate 110 for locking the same is disclosed, one having skills in the art would recognize that other kind of springs, such as a coil spring, may also serve the purpose.

Although the present invention discloses an embodiment with the electrical sockets 124 separated from the base plate 120, one having skills in the art would recognize that the cover plate locking mechanism by the pin 130 may be applied to other types of electrical socket covers, such as the one with the base plate 120 integrated to the electrical sockets 124.

The above illustration provides many different embodiments or embodiments for implementing different features of the invention. Specific embodiments of components and processes are described to help clarify the invention. These are, of course, merely embodiments and are not intended to limit the invention from that described in the claims.

Although the invention is illustrated and described herein as embodied in one or more specific examples, it is nevertheless not intended to be limited to the details shown, since various modifications and structural changes may be made therein without departing from the spirit of the invention and within the scope and range of equivalents of the claims. Accordingly, it is appropriate that the appended claims be construed broadly and in a manner consistent with the scope of the invention, as set forth in the following claims.

1. An electrical socket cover, comprising:
a base plate mounted on an electrical receptacle having a plurality of electrical sockets, the base plate having a plurality of apertures for exposing the plurality of electrical sockets, respectively;
a cover plate when in a closed position substantially covers the plurality of electrical sockets;
a sliding means that allows the cover plate to slidably engage the base plate; and
a locking assembly, comprising a pin slidably engaging the base plate through an opening thereon, the walls of the opening being substantially perpendicular to the base plate, and the sliding being substantially entirely linear, a spring mounted on the base plate for urging the pin toward the cover plate, and an opening on the cover plate for accommodating the pin,
wherein when in the closed position a first end of the pin is inserted in the opening of the cover plate for locking the cover plate, and when the pin is pressed away from the cover plate, the cover plate is unlocked and slidable to an open position for exposing one or more of the plurality of electrical sockets.

2. The electrical socket cover of claim 1, wherein the sliding means comprises a pair of grooves formed on the cover plate that fits two elongated edges on the base plate.

3. The electrical socket cover of claim 1, wherein the sliding means comprises a pair of grooves formed on the base plate that fit two elongated edges on the cover plate.

4. The electrical socket cover of claim 1, wherein the first end of the pin have a slanted surface for facilitating the cover plate to disengage the pin.

5. The electrical socket cover of claim 1, wherein the cover plate comprises a slanted surface to facilitate the cover plate to slide back into the closed position.

6. The electrical socket cover of claim 1, wherein the cover plate comprises a plurality of openings so positioned that when the cover plate is in the closed position, the plurality of electrical sockets are covered, and when the cover plate is a open position, the plurality of openings are aligned with the plurality of electrical sockets for exposing the same.

7. The electrical socket cover of claim 1, wherein the base plate is made of plastic material.

8. The electrical socket cover of claim 1, wherein the base plate is an integral part of the electrical receptacle.

9. An electrical socket cover, comprising:
a base plate mounted on an electrical receptacle having a plurality of electrical sockets, the base plate having a plurality of apertures for exposing the plurality of electrical sockets, respectively;
a cover plate when in a closed position substantially covers the plurality of electrical sockets;
a pair of grooves formed on the cover plate that fit two edges on the base plate for allowing the cover plate to slidably engage the base plate; and
a locking assembly, comprising a pin slidably engaging the base plate through an opening thereon, the walls of the opening being substantially perpendicular to the base plate, and the sliding being substantially entirely linear, a spring mounted on the base plate for urging the pin toward the cover plate, and an opening on the cover plate for accommodating the pin,
wherein when in the closed position a first end of the pin is inserted in the opening of the cover plate for locking the cover plate, and when the pin is pressed away from the cover plate, the cover plate is unlocked and slidable to an open position for exposing one or more of the plurality of electrical sockets.

10. The electrical socket cover of claim 9, wherein the first end of the pin have a slanted surface for facilitating the cover plate to disengage the pin.

11. The electrical socket cover of claim 9, wherein the cover plate comprises a slanted surface to facilitate the cover plate to slide back into the closed position.

12. The electrical socket cover of claim 9, wherein the cover plate comprises a plurality of openings so positioned that when the cover plate is in the closed position, the plurality of electrical sockets are covered, and when the cover plate is a open position, the plurality of openings are aligned with the plurality of electrical sockets for exposing the same.

13. The electrical socket cover of claim 9, wherein the base plate is made of plastic material.

14. The electrical socket cover of claim 9, wherein the base plate is an integral part of the electrical receptacle.

15. An electrical socket cover, comprising:
a base plate mounted on an electrical receptacle having a plurality of electrical sockets, the base plate having a plurality of apertures for exposing the plurality of electrical sockets, respectively;
a cover plate when in a closed position substantially covers the plurality of electrical sockets;
a pair of grooves formed on the base plate that fit two edges on the cover plate for allowing the cover plate to slidably engage the base plate; and
a locking assembly, comprising a pin slidably engaging the base plate through an opening thereon, the walls of the opening being substantially perpendicular to the base plate, and the sliding being substantially entirely linear, a spring mounted on the base plate for urging the pin toward the cover plate, and an opening on the cover plate for accommodating the pin,
wherein when in the closed position a first end of the pin is inserted in the opening of the cover plate for locking the same, and when the pin is pressed away from the cover plate, the cover plate is unlocked and slidable to an open position for exposing one or more of the plurality of electrical sockets.

16. The electrical socket cover of claim 15, wherein the first end of the pin have a slanted surface for facilitating the cover plate to disengage the pin.

17. The electrical socket cover of claim 15, wherein the cover plate comprises a slanted surface to facilitate the cover plate to slide back into the closed position.

18. The electrical socket cover of claim 15, wherein the cover plate comprises a plurality of openings so positioned that when the cover plate is in the closed position, the plurality of electrical sockets are covered, and when the cover plate is a open position, the plurality of openings are aligned with the plurality of electrical sockets for exposing the same.

19. The electrical socket cover of claim 15, wherein the base plate is made of plastic material.

20. The electrical socket cover of claim 15, wherein the base plate is an integral part of the electrical receptacle.
